(19) United States
(12) Patent Application Publication
(10) Pub. No.: US 2015/0349687 A1
(43) Pub. Date: Dec. 3, 2015

(54) Electric Power Generation and Distribution for Islanded or Weakly-Connected Systems

(71) Applicant: ABB Technology AG, Zurich (CH)

(72) Inventors: Jiaqi Liang, Cary, NC (US); Li Qi, Cary, NC (US); Zhiguo Pan, Cary, NC (US)

(21) Appl. No.: 14/291,176

(22) Filed: May 30, 2014

(51) Int. Cl. H02P 9/00

(52) U.S. Cl. CPC H02P 9/007

(57) ABSTRACT

A dual-voltage power generation system includes a prime mover configured for adjustable speed operation and a doubly-fed induction generator driven by the prime mover and including a multi-phase stator winding and a multi-phase rotor winding. A first output terminal of the dual-voltage power generation system is electrically connected to the multi-phase stator winding, and a second output terminal is electrically connected to the multi-phase rotor winding. The dual-voltage power generation system further includes a first converter having an AC side connected to one of the multi-phase windings and an AC or DC side connected to one of the output terminals. The multi-phase stator winding has a different turns ratio than the multi-phase rotor winding and the first output terminal is electrically isolated from the second output terminal so that the generator has two isolated power supply outputs at different voltage levels in a first configuration.

### TECHNICAL FIELD

The instant application relates to islanded or weakly-connected DC or mixed DC-AC power systems, and more particularly to electric power generation and distribution systems for islanded or weakly-connected DC or mixed DC-AC power systems.

### BACKGROUND

Conventional electric power generation and distribution systems for islanded or weakly-connected DC or mixed DC-AC power systems such as shipboard and off-shore power systems typically use single-voltage generation systems having synchronous or induction generators driven by prime movers. The windings of each generator are electrically connected to one another to form a single voltage output for each generation system. The generator winding connections are typically realized by transformers, DC/DC converters or AC/DC converters to form the single voltage output. Such systems have rigid prime mover speed requirements and limited voltage flexibility, high cost and lower efficiency.

### SUMMARY

According to an embodiment of a dual-voltage power generation system, the power generation system comprises a prime mover configured for adjustable speed operation and a doubly-fed induction generator driven by the prime mover and comprising a multi-phase stator winding and a multi-phase rotor winding. A first output terminal of the dual-voltage power generation system is electrically connected to the multi-phase stator winding, and a second output terminal is electrically connected to the multi-phase rotor winding. The dual-voltage power generation system further comprises a first converter having an AC side connected to one of the multi-phase windings and an AC or DC side connected to one of the output terminals. The multi-phase stator winding has a different turns ratio than the multi-phase rotor winding and the first output terminal is electrically isolated from the second output terminal so that the generator has two isolated power supply outputs at different voltage levels in a first configuration.

According to an embodiment of a method of configuring a dual-voltage power generation system for operation, the method comprises: configuring a prime mover for driving a doubly-fed induction generator at variable speed, the generator comprising a multi-phase stator winding and a multi-phase rotor winding having different turns ratios; electrically connecting a first output terminal of the dual-voltage power generation system to the multi-phase stator winding; electrically connecting a second output terminal of the dual-voltage power generation system to the multi-phase rotor winding; connecting an AC side of a first converter to one of the multi-phase windings and an AC or DC side of the first converter to one of the output terminals; and electrically isolating the first output terminal from the second output terminal so that the dual-voltage power generation system has two isolated power supply outputs at different voltage levels in a first configuration.

According to an embodiment of a power generation and distribution system, the system comprises a higher-voltage DC bus for supplying power to large drive-fed motors, a lower-voltage DC bus for supplying power to small drive-fed motors and a first plurality of dual-voltage power generation systems. Each of the dual-voltage power generation systems comprises a prime mover configured for adjustable speed operation, a doubly-fed induction generator driven by the prime mover and comprising a multi-phase stator winding and a multi-phase rotor winding having different turns ratios, a first DC output terminal electrically connected to the higher-voltage DC bus, and a second DC output terminal electrically connected to the lower-voltage DC bus and electrically isolated from the first DC output terminal. Each of the dual-voltage power generation systems further comprises a first converter having an AC side connected to the multi-phase stator winding and a DC side connected to the first DC output terminal and a second converter having an AC side connected to the multi-phase rotor winding and a DC side connected to the second DC output terminal.

According to another embodiment of a power generation and distribution system, the system comprises a higher-voltage DC bus for supplying power to drive-fed motors, a lower-voltage AC bus for supplying power to at least one of direct-on-line AC motors and auxiliary AC loads and a plurality of dual-voltage power generation systems. Each of the dual-voltage power generation systems comprises a prime mover configured for adjustable speed operation, a doubly-fed induction generator driven by the prime mover and comprising a multi-phase stator winding and a multi-phase rotor winding having different turns ratios, a DC output terminal electrically connected to the higher-voltage DC bus, an AC output terminal directly connected to the multi-phase rotor winding and electrically connected to the lower-voltage AC bus, the AC output terminal being electrically isolated from the DC output terminal, and a converter having an AC side connected to the multi-phase stator winding and a DC side connected to the DC output terminal.

Those skilled in the art will recognize additional features and advantages upon reading the following detailed description, and upon viewing the accompanying drawings.

### BRIEF DESCRIPTION OF THE DRAWINGS

The components in the figures are not necessarily to scale, instead emphasis being placed upon illustrating the principles of the invention. Moreover, in the figures, like reference numerals designate corresponding parts. In the drawings:

FIG. 1 illustrates a block diagram of an embodiment of a dual-voltage power generation system.

FIG. 2 illustrates a schematic diagram showing different operational configurations for the dual-voltage power generation system of FIG. 1.

FIG. 3 illustrates a block diagram of an embodiment of a dual-voltage power generation system with a plurality of multi-phase stator windings.

FIG. 4 illustrates a block diagram of an embodiment of a mixed AC-DC dual-voltage power generation system.

FIG. 5 illustrates a block diagram of another embodiment of a mixed AC-DC dual-voltage power generation system.

FIG. 6 illustrates a block diagram of an embodiment of a power generation and distribution system for islanded or weakly-connected DC or mixed DC-AC power systems.

FIG. 7 illustrates a block diagram of another embodiment of a power generation and distribution system for islanded or weakly-connected DC or mixed DC-AC power systems.

### DETAILED DESCRIPTION

According to the embodiments described herein, electric power generation and distribution are provided for islanded or weakly-connected DC or mixed DC-AC power systems such as shipboard and off-shore power systems. The electric power generation and distribution systems include a combination of double-fed induction generators (DFIGs) and power electronic converters configured to output at least two isolated voltage levels without using transformers, DC/DC converters or AC/DC converters to electrically connect the windings of each DFIG. For example, a typical configuration can include a medium voltage output and a low voltage output. The output voltages may be all in DC or a mix of DC and AC. The overall generation and distribution system has reduced weight, volume and capital cost compared to conventional systems.

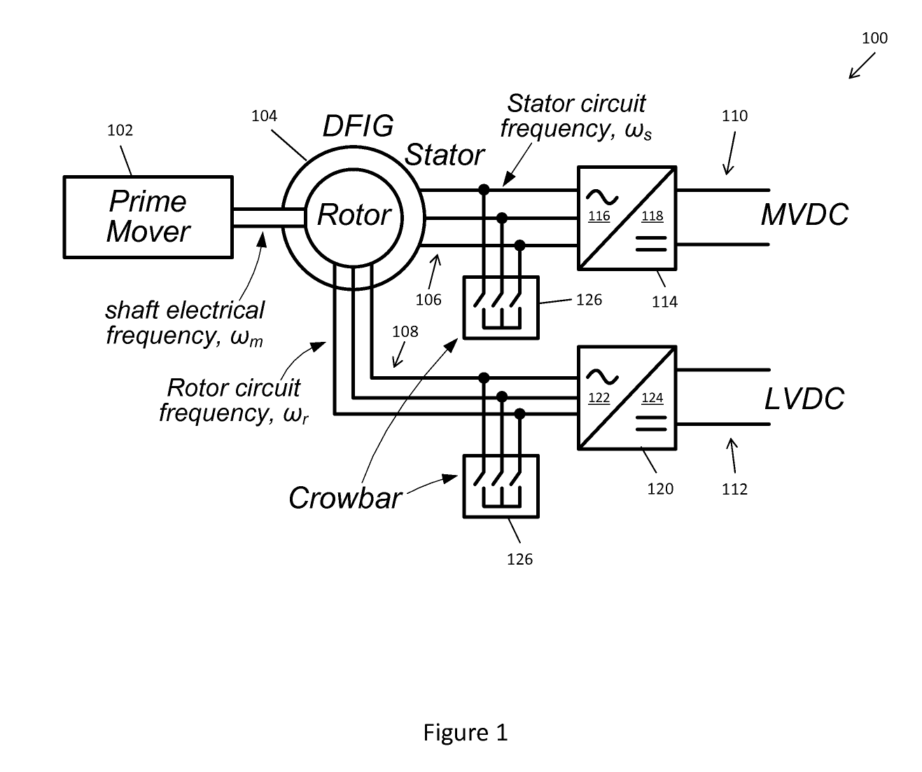

FIG. 1 illustrates an embodiment of a dual-voltage power generation system 100 for use in an electric power generation and distribution system for islanded or weakly-connected DC or mixed DC-AC power systems. The dual-voltage power generation system 100 comprises a prime mover 102 configured for adjustable speed operation. The prime mover 102 can be of any type, such as a diesel engine, gas engine, wind turbine, hydro turbine, etc. A doubly-fed induction generator (DFIG) 104 is driven by the prime mover 102. DFIGs are similar to wound rotor induction machines and comprise a multi-phase stator winding 106 and a multi-phase rotor winding 108. The multi-phase rotor winding 108 is typically fed via slip rings. The multi-phase stator winding 106 has a different turns ratio than the multi-phase rotor winding 108 such that that stator of the DFIG 104 outputs one voltage level (e.g. medium voltage) and the rotor outputs a second voltage level (e.g. low voltage). The dual-voltage power generation system 100 also has a first output terminal 110 electrically connected to the multi-phase stator winding 106 of the DFIG 104, and a second output terminal 112 electrically connected to the multi-phase rotor winding 108 of the DFIG 104.

The dual-voltage power generation system 100 further comprises at least a first converter 114 having an AC side 116 connected to one of the multi-phase windings 106, 108 and an AC or DC side 118 connected to one of the output terminals 110, 112. The first converter 114 can be any standard converter such as an AC/DC converter or an AC/DC/AC converter. While the first converter 114 is shown as an AC(˜)/DC(=) converter in FIG. 1 for purely illustrative purposes, this is not intended to be limiting in that the first converter 114 instead can be an AC/DC/AC converter or any other type of standard converter. In the case of an AC/DC converter as shown in FIG. 1, the output terminal of the dual-voltage power generation system 100 connected to the converter 114 is a DC output terminal. In the case of an AC/DC/AC converter, the output terminal connected to the converter 114 is an AC output terminal. In either case, the output terminals 110, 112 of the dual-voltage power generation system 100 are electrically isolated from one another so that the DFIG 104 has two isolated power supply outputs at different voltage levels (MVDC, LVDC) in a first configuration.

According to the embodiment of FIG. 1, the first converter 114 is an AC/DC converter having its AC side 116 connected to the multi-phase stator winding 106 of the DFIG 104 and its DC side 118 connected to the first output terminal 110. The dual-voltage power generation system 100 further comprises a second AC/DC converter 120 according to this embodiment. The second converter 120 is also an AC/DC converter according to this embodiment, and has an AC side 122 connected to the multi-phase rotor winding 108 of the DFIG 104 and a DC side 124 connected to the second output terminal 112. With this configuration, the first output terminal 110 is electrically connected to the multi-phase stator winding 106 via the first AC/DC converter 114 and the second output terminal 112 is electrically connected to the multi-phase rotor winding 108 via the second AC/DC converter 120. While the second converter 120 is shown as an AC(˜)/DC(=) converter in FIG. 1 for purely illustrative purposes, this is not intended to be limiting in that the second converter 120 instead can be an AC/DC/AC converter or any other type of standard converter. One of the converters 114, 120 can be omitted as explained above if desired so that one of the output terminals 110, 112 is directly connected to the corresponding multi-phase winding 106, 108 of the DFIG 104 without an intervening converter in the electrical path. As such, the term “directly connected” as used herein means electrically connected without an intervening converter between the points of connection.

Owing to the different turns ratio between the multi-phase stator and rotor windings 106, 108 of the DFIG 104, the first output terminal 110 of the dual-voltage power generation system 100 i.e. the terminal connected to the DC side 118 of the first AC/DC converter 114 is at a higher DC voltage level (e.g. a relatively medium voltage or MVDC in FIG. 1) in the embodiment of FIG. 1. The second output terminal 112 of the dual-voltage power generation system 100 i.e. the terminal connected to the DC side 124 of the second AC/DC converter 120 is at a lower DC voltage level (e.g. a relatively low voltage or LVDC in FIG. 1). One or both of the output terminals 110, 112 can be AC output terminals instead of DC output terminals by replacing the corresponding AC/DC converter with an AC/DC/AC converter.

In some embodiments, at least one of the AC/DC converters 114, 120 is a self-commutated AC/DC converter i.e. both turn-on and turn-off of the converter can be controlled. Each self-commutated AC/DC converter can control the frequency of voltage and current at the AC side 116, 122 of the self-commutated AC/DC converter. The dual-voltage power generation system 100 can also include an optional crowbar circuit 126 connected to the multi-phase winding 106, 108 at the AC side 116, 122 of the first and/or second converter 114, 120. Each crowbar circuit 126 is operable to bypass the converter 114, 120 to which it is connected and short-circuit the corresponding multi-phase winding 106, 108 of the DFIG 104 at the AC side 116, 122 of that converter 114, 120. The construction and operation of crowbar circuits is well known in the electric power generation and distribution arts, and therefore no further explanation is given in this regard.

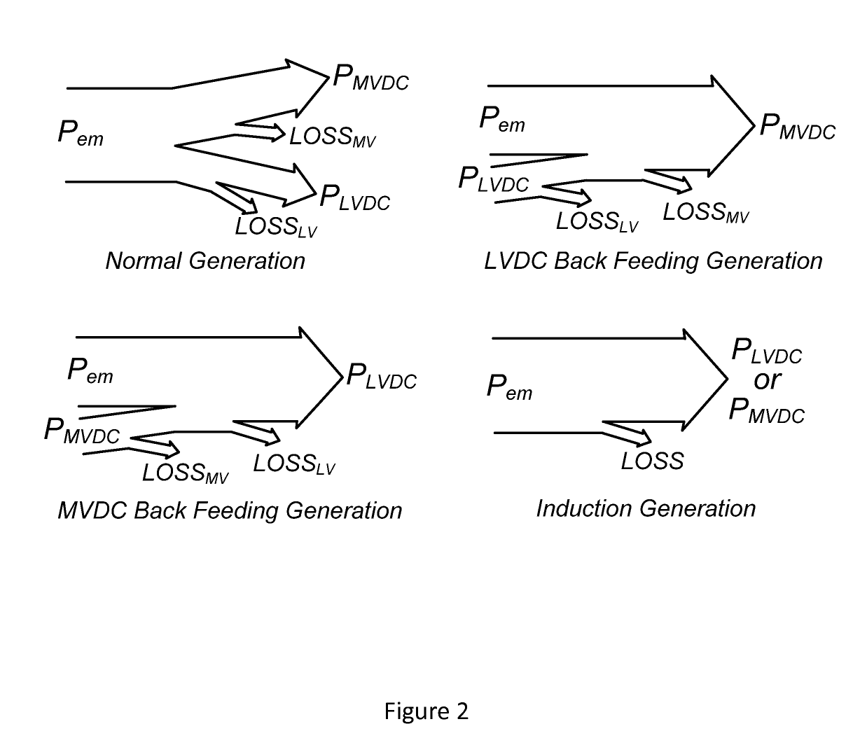

Operation of the dual-voltage power generation system 100 of FIG. 1 is explained next in greater detail with reference to FIG. 2. FIG. 2 shows different operational configurations of the dual-voltage power generation system 100, for achieving optimal efficiency of the prime mover 102 and variable and bidirectional power sharing between the two buses connected to the output terminals 110, 112 of the dual-voltage power generation system 100.

The dual-voltage power generation system 100 is set in a first configuration when ωₘ>ωₛ and ωₘ=ωₛ+ωᵣ, where ωₘ is the equivalent electrical frequency of rotation of the prime mover 102, ωₛ is the electrical frequency of the multi-phase stator winding 106 and ωᵣ is the electrical frequency of the multi-phase rotor winding 108. In the first configuration (the diagram labeled “Normal Generation” in FIG. 2), the first and second AC/DC converters 114, 120 are both configured to operate as a rectifier. Power generation (P_{MVDC}) into the MVDC (medium voltage DC) bus is a fraction of the electromechanical power Pₑₘ of the system 100 as given by:

P_{MVDC}=(ωₛ/ωₘ)Pₑₘ−LOSS_{MV} (1)

where LOSS_{MV} is power loss along the MVDC path. Power generation into the LVDC bus is the remaining fraction of the electromechanical power as given by:

P_{LVDC}=(ωᵣ/ωₘ)Pₑₘ−LOSS_{LV} (2)

where LOSS_{LV} is power loss along the LVDC path. Power generation to either the LVDC or MVDC bus may be independently reduced to zero. The shaft speed of the prime mover 102 is variable, which allows optimal efficiency of the prime mover 102.

The dual-voltage power generation system 100 is set in a second configuration when ωₛ>ωₘ and ωₛ=ωₘ+ωᵣ. To enable the second configuration (the diagram labeled “LVDC Back Feeding Generation” in FIG. 2), the AC/DC converter 120 connected to the multi-phase rotor winding 108 is a self-commutated AC/DC converter configured to operate as an inverter and the AC/DC converter 114 connected to the multi-phase stator winding 106 is configured to operate as a rectifier. In the second configuration, electric power flows from the second output terminal 112 via the LVDC bus into the multi-phase rotor winding 108.

The dual-voltage power generation system 100 is set in a third configuration when ωₛ<ωₘ and ωᵣ=ωₘ+ωₛ. To enable the third configuration (the diagram labeled “MVDC Back Feeding Generation” in FIG. 2), the AC/DC converter 114 connected to the multi-phase stator winding 106 is a self-commutated AC/DC converter configured to operate as an inverter and the AC/DC converter 120 connected to the multi-phase rotor winding 108 is configured to operate as a rectifier. In the third configuration, electric power flows from the first output terminal 110 via the MVDC bus into the multi-phase stator winding 106.

In case of stator (or rotor) side AC/DC converter failure, the dual-voltage power generation system 100 is set in a fourth configuration. In the fourth configuration, the stator (or rotor) side crowbar circuit 126 bypasses the faulty converter 114/120 and short-circuits the stator (or rotor) terminals. The generator 100 continues to operate in induction mode and generates power into the rotor (or stator) side circuit.

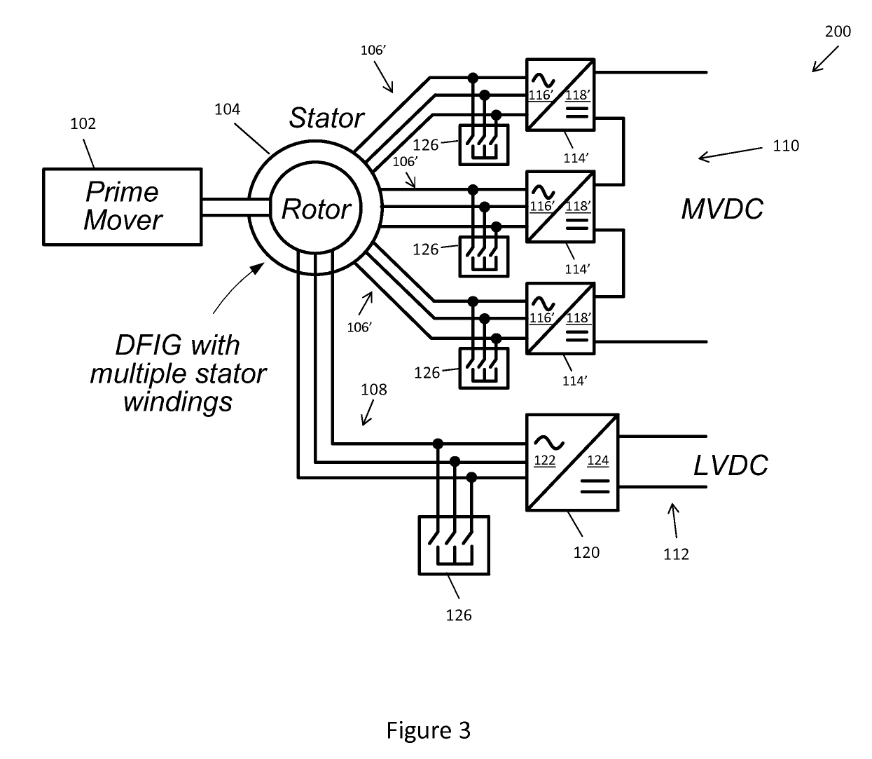

FIG. 3 illustrates another embodiment of a dual-voltage power generation system 200 for use in an electric power generation and distribution system for islanded or weakly-connected DC or mixed DC-AC power systems. The embodiment shown in FIG. 3 is similar to the embodiment shown in FIG. 1, however, the stator of the DFIG 104 has a plurality of multi-phase stator windings 106′ and each of the multi-phase stator windings 106 is connected to an AC side 116′ of a respective first AC/DC converter 114′. Alternatively, the rotor of the DFIG 104 can have a plurality of multi-phase rotor windings (not shown in FIG. 3) and each of the multi-phase rotor windings is similarly connected to an AC side of an AC/DC converter. In yet another embodiment, the stator and rotor of the DFIG 104 each have a plurality of multi-phase windings each of which is connected to an AC side of an AC/DC converter. In each case, the DC side 118′ of the first AC/DC converters 114′ can be connected in series as shown in FIG. 3 or in parallel to achieve specific voltage or current requirements. By different combinations of series and parallel connections, multiple DC voltage levels can be obtained from the DFIG stator and/or rotor windings 106, 108.

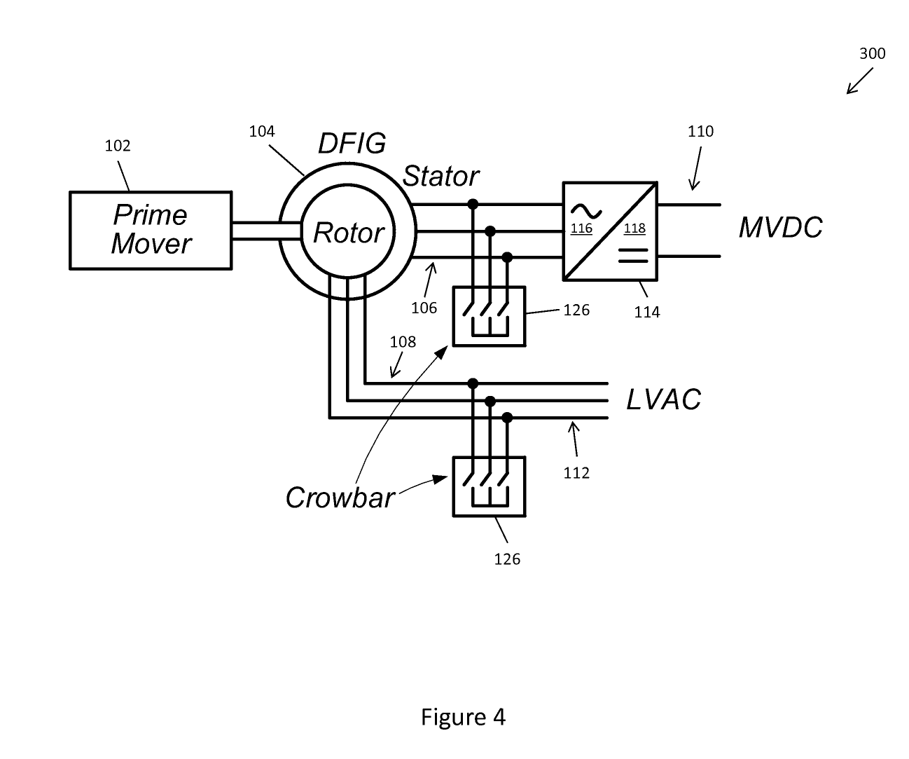

FIG. 4 illustrates yet another embodiment of a dual-voltage power generation system 300 for use in an electric power generation and distribution system for islanded or weakly-connected DC or mixed DC-AC power systems. The embodiment shown in FIG. 4 is similar to the embodiment shown in FIG. 1, however, the second converter 120 (on the rotor side) is omitted. As such, the dual-voltage power generation system 300 is a mixed DC-AC generation system that outputs isolated AC and DC voltage levels (LVAC, MVDC). The mixed DC-AC generation system 300 includes a DFIG 104 and one self-commutated AC/DC converter 114 having its AC side 116 connected to the multi-phase stator winding 106 of the DFIG 104 and its DC side 118 connected to the first output terminal 110. The second output terminal 112 is directly connected to the multi-phase rotor winding 108 of the DFIG 104 and outputs an AC voltage (LVAC) according to this embodiment. Optional crowbar circuits 126 can be connected to the DFIG stator and/or rotor multi-phase windings 106, 108.

The mixed DC-AC power generation system 300 can output a variable or fixed AC frequency depending on the system design. For variable AC frequency operation, the AC output (LVAC) of the mixed DC-AC power generation system 300 has a variable frequency. The prime mover 102 controls the shaft frequency and the AC/DC converter 114 controls its AC-side electrical frequency. The prime mover 102 is in variable-speed operation to achieve optimal efficiency. Power sharing between the DC and AC outputs 110, 112 is independent from the shaft speed. Depending on the relationship between the stator, rotor, and shaft electrical frequencies, the power flow scenarios between the DC and AC outputs 110, 1112 is the same as those illustrated in FIG. 2.

For fixed AC frequency operation, the AC output 112 of the mixed DC-AC power generation system 300 has a fixed frequency. The prime mover 102 controls the shaft frequency and the AC/DC converter 114 controls its AC-side electrical frequency. Power sharing between the DC and AC outputs 110, 112 is dependent on the shaft speed. All four power configurations illustrated in FIG. 2 are applicable, but the prime mover 102 may not be able to operate at optimal efficiency points.

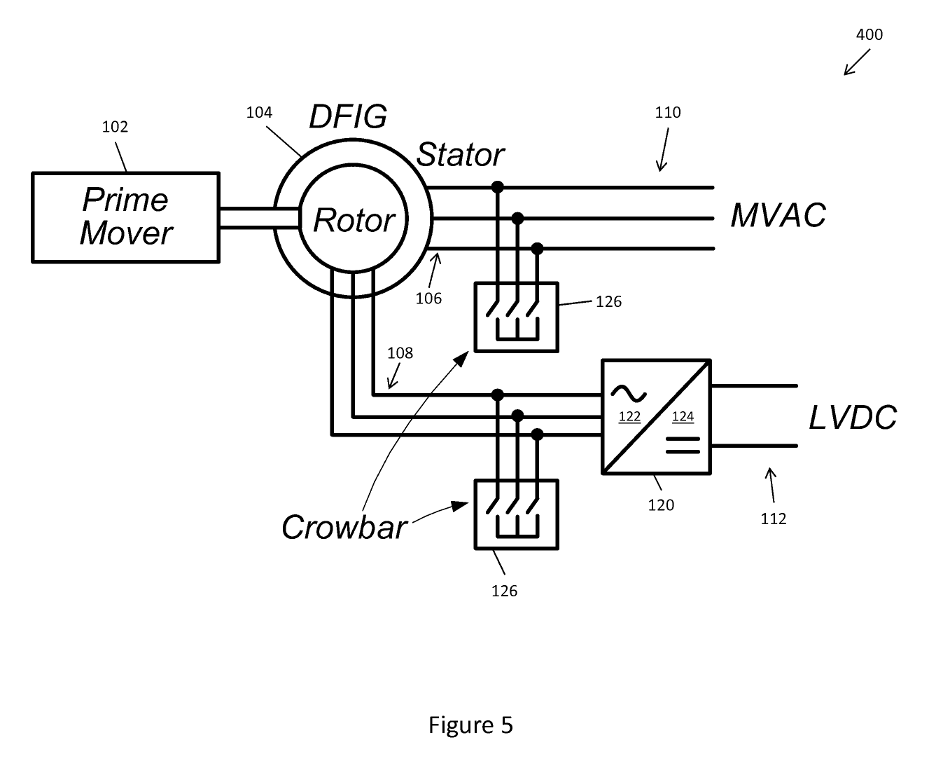

FIG. 5 illustrates still another embodiment of a dual-voltage power generation system 400 for use in an electric power generation and distribution system for islanded or weakly-connected DC or mixed DC-AC power systems. The embodiment shown in FIG. 5 is similar to the embodiment shown in FIG. 4, however, the first converter 114 is omitted and the second converter 120 is a self-commutated AC/DC converter having its AC side 122 connected to the multi-phase rotor winding 108 of the DFIG 104 and its DC side 124 connected to the second output terminal 112. The first output terminal 110 is directly connected to the multi-phase stator winding 106 and outputs an AC voltage (MVAC in FIG. 5) according to this embodiment. The mixed DC-AC power generation system 400 can output a variable or fixed AC frequency depending on the system design, similarly as explained above in connection with FIG. 4.

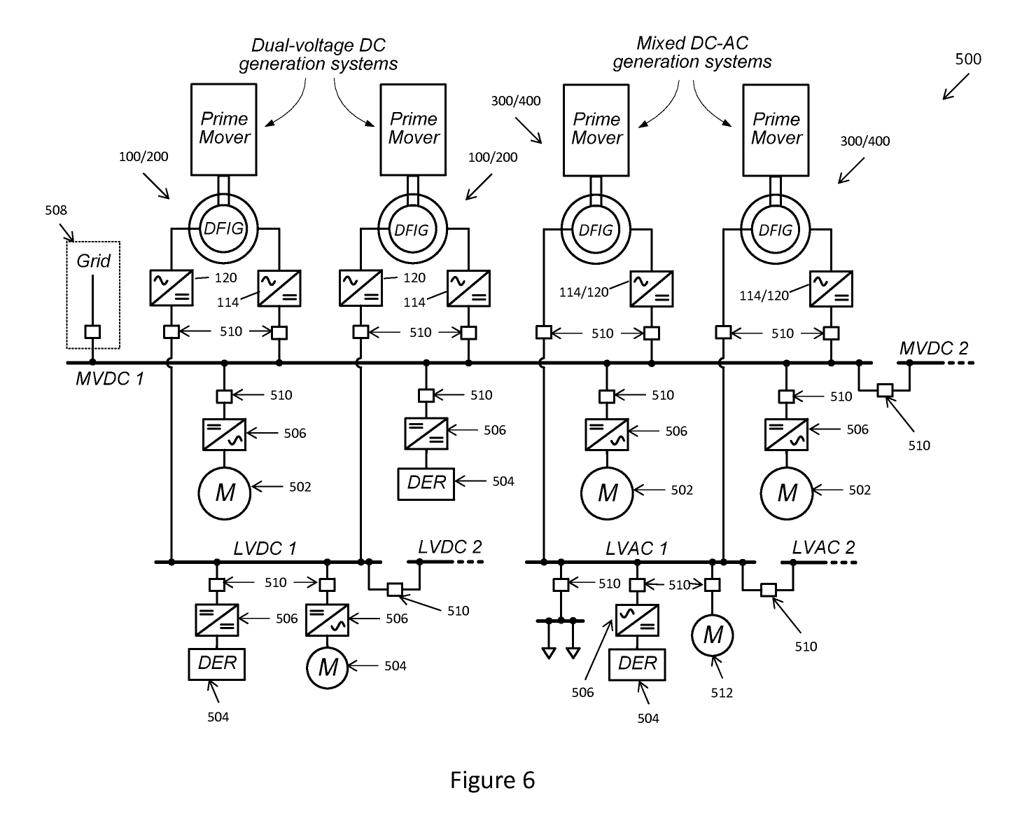

FIG. 6 illustrates an embodiment of a power generation and distribution system 500 for islanded or weakly-connected DC or mixed DC-AC power systems such as shipboard and off-shore power systems. The power generation and distribution system 500 includes at least one higher-voltage DC bus (MVDC1, MVDC2) for supplying power to large drive-fed motors 502 and at least one lower-voltage DC bus (LVDC1, LVDC2) for supplying power to small drive-fed motors 504. By using the dual-voltage power generation systems 100/200/300/400 previously described herein to power the DC buses, a medium voltage (MV) and low voltage (LV) DC distribution system can be realized without the need for DC/DC converters between the MV and LV DC buses. A first group of the dual-voltage power generation systems 100/200 previously described herein are configured to have a first DC output terminal 110 electrically connected to the higher-voltage DC bus and a second DC output terminal 112 electrically connected to the lower-voltage DC bus. Accordingly, the AC side (˜) of the first converter 114 for each of these dual-voltage power generation systems 100/200 is connected to the multi-phase stator winding 106 of the corresponding DFIG 104 and the DC side (=) is connected to the first DC output terminal 110. Similarly, the AC side (˜) of the second converter 120 is connected to the multi-phase rotor winding 108 of the corresponding DFIG 104 and the DC side (=) is connected to the second DC output terminal 112.

In each dual-voltage power generation system 100/200 of the first group, power sharing between the MV and LV DC outputs 110, 112 is independent from the shaft speed. Power flow into the MV or LV DC buses is reversible. Distributed energy resources (DERs) 504, including energy storage and fuel cells, can be connected to the LVDC bus, MVDC bus, or both. DERs 504 connected to either bus can be used to compensate for load consumption at both buses. The AC loads may be supplied from the LVDC bus or from the MVDC bus (not shown) through DC/AC converters 506. Optional grid (AC or DC grid) connections 508 can exist for some amount of energy exchange depending on specific applications. An AC grid connection can be connected to the MVDC bus or to the LVDC bus (not shown). Switches 510 with protection functions are connected between converters and DC buses, and between multiple DC busses.

The power generation and distribution system 500 can also include a second group of the dual-voltage power generation systems 300/400 previously described herein, configured to have a DC output terminal 110/112 electrically connected to the higher-voltage DC bus and an AC output terminal 112/110 directly connected to the multi-phase stator winding 108 of the corresponding DFIG 104. The dual-voltage power generation systems 300/400 in the second group each have a single AC/DC converter 114/120. The AC side (˜) of the converter 114/120 is connected to the multi-phase stator or rotator winding 108, 108 of the corresponding DFIG 104, and the DC side (=) of the converter 114/120 is connected to the corresponding DC output terminal 110/112. The AC output terminal 112/110 of the dual-voltage power generation systems 300/400 in the second group are also electrically connected to a lower-voltage AC bus (LVAC1, LVAC2). The lower-voltage AC buses supply power to at least one of direct-on-line AC motors and auxiliary AC loads 512.

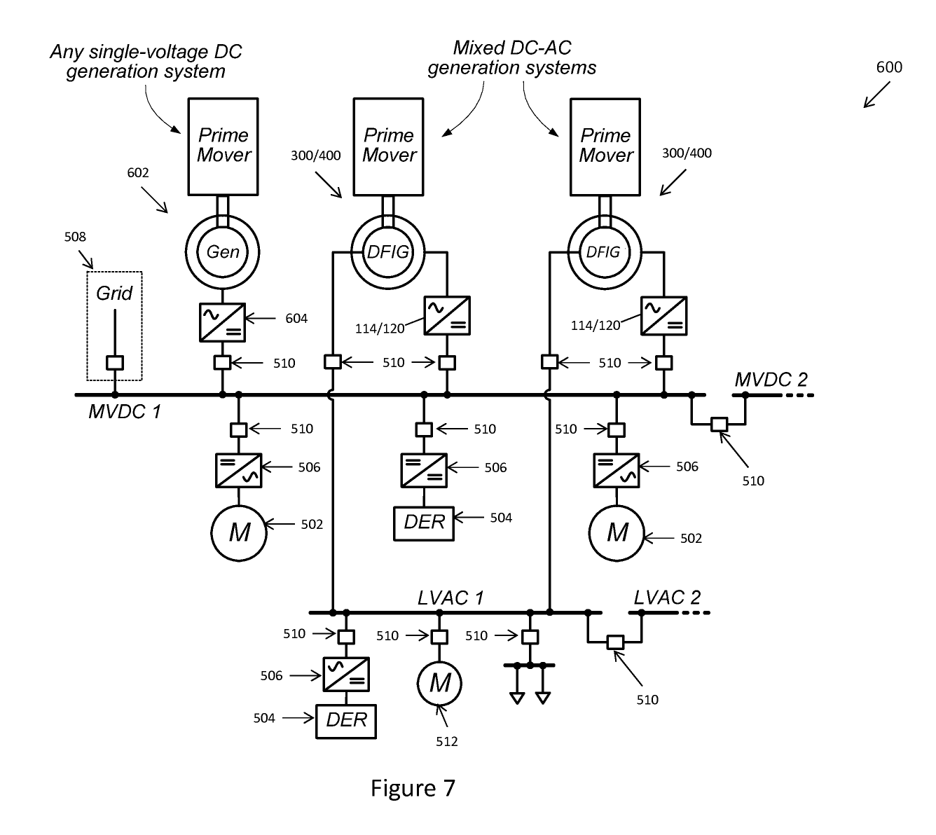

FIG. 7 illustrates another embodiment of a power generation and distribution system 600 for islanded or weakly-connected DC or mixed DC-AC power systems such as shipboard and off-shore power systems. The embodiment shown in FIG. 7 is similar to the one shown in FIG. 6 in that the power generation and distribution system 600 in FIG. 7 is a mixed DC-AC distribution system which uses the DC and mixed DC-AC generation systems 100/200/300/400 described above in connection with FIG. 6 to provide DC and mixed DC-AC voltage outputs. The power generation and distribution system 600 of FIG. 7 also includes single-voltage power generation systems 602 with an AC/DC converter 604 for energizing the medium voltage DC buses (MVDC1, MVDC2). The power generation and distribution system 600 of FIG. 7 also includes mixed DC-AC dual-voltage power generation systems 300/400 of the kind previously described herein.

Each mixed DC-AC dual-voltage power generation system 300/400 has one converter 114/120 for electrically connecting the multi-phase stator or rotor winding 106, 108 of the corresponding DFIG 104 to one of the MVDC buses (MVDC1, MVDC2) via the DC output terminal 110/112 of the respective mixed DC-AC dual-voltage power generation system 300/400. The AC output terminal 112/110 of each mixed DC-AC dual-voltage power generation system 300/400 is directly connected to the other multi-phase winding 106, 108 of the DFIG 104 and electrically connected to a lower-voltage AC bus (LVAC1, LVAC2). The medium voltage DC buses connect to the DC outputs 110/112 of the mixed DC-AC dual-voltage power generation systems 300/400 and the DC outputs of the single-voltage power generation systems 602, and supply energy to large drive-fed motor loads 502. The low voltage AC buses (LVAC1, LVAC2) connect to the AC outputs 112/110 of the mixed DC-AC dual-voltage power generation systems 300/400, and supply energy to direct-on-line AC motors and/or auxiliary AC loads 512. DERs 504, including energy storage and fuel cells, can be connected to the MVDC bus and/or LVAC bus and an optional grid 508 can connect to the MVDC bus or LVAC bus (not shown) as previously described herein in connection with FIG. 6.

Terms such as “first”, “second”, and the like, are used to describe various elements, regions, sections, etc. and are not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A dual-voltage power generation system, comprising:
a prime mover configured for adjustable speed operation;
a doubly-fed induction generator driven by the prime mover and comprising a multi-phase stator winding and a multi-phase rotor winding;
a first output terminal electrically connected to the multi-phase stator winding;
a second output terminal electrically connected to the multi-phase rotor winding; and
a first converter having an AC side connected to one of the multi-phase windings and an AC or DC side connected to one of the output terminals,
wherein the multi-phase stator winding has a different turns ratio than the multi-phase rotor winding and the first output terminal is electrically isolated from the second output terminal so that the generator has two isolated power supply outputs at different voltage levels in a first configuration.

2. The dual-voltage power generation system of claim 1, wherein the first converter is an AC/DC converter having an AC side connected to one of the multi-phase windings and a DC side connected to one of the output terminals.

3. The dual-voltage power generation system of claim 2, further comprising a second AC/DC converter having an AC side connected to the other one of the multi-phase windings and a DC side connected to the other one of the output terminals.

4. The dual-voltage power generation system of claim 3, wherein at least one of the AC/DC converters is a self-commutated AC/DC converter operable to control the frequency of voltage and current at the AC side of the self-commutated AC/DC converter.

5. The dual-voltage power generation system of claim 3, wherein the first and the second AC/DC converter are both configured to operate as a rectifier if ωₘ>ωₛ and ωₘ=ωₛ+ωᵣ so that the generator is set in the first configuration, where ωₘ is the equivalent electrical frequency of rotation of the prime mover, ωₛ is the electrical frequency of the multi-phase stator winding and ωᵣ is the electrical frequency of the multi-phase rotor winding.

6. The dual-voltage power generation system of claim 3, wherein the AC/DC converter connected to the multi-phase rotor winding is a self-commutated AC/DC converter configured to operate as an inverter and the AC/DC converter connected to the multi-phase stator winding is configured to operate as a rectifier if ωₛ>ωₘ and ωₛ=ωₘ+ωᵣ so that the generator is set in a second configuration in which electric power flows from the second output terminal into the multi-phase rotor winding, where ωₘ is the equivalent electrical frequency of rotation of the prime mover, ωₛ is the electrical frequency of the multi-phase stator winding and ωᵣ is the electrical frequency of the multi-phase rotor winding.

7. The dual-voltage power generation system of claim 3, wherein the AC/DC converter connected to the multi-phase stator winding is a self-commutated AC/DC converter configured to operate as an inverter and the AC/DC converter connected to the multi-phase rotor winding is configured to operate as a rectifier if ωₛ<ωₘ and ωᵣ=ωₘ+ωₛ so that the generator is set in a third configuration in which electric power flows from the first output terminal into the multi-phase stator winding, where ωₘ is the equivalent electrical frequency of rotation of the prime mover, ωₛ is the electrical frequency of the multi-phase stator winding and ωᵣ is the electrical frequency of the multi-phase rotor winding.

8. The dual-voltage power generation system of claim 1, further comprising a crowbar circuit connected to the multi-phase winding at the AC side of the first converter, the crowbar circuit operable to bypass the first converter and short-circuit the multi-phase winding at the AC side of the first converter.

9. The dual-voltage power generation system of claim 1, wherein at least one of the rotor and the stator of the generator has a plurality of multi-phase windings, and wherein each of the plurality of multi-phase windings is connected to the AC side of the first converter.

10. The dual-voltage power generation system of claim 1, wherein the first converter is a self-commutated AC/DC converter having an AC side connected to one of the multi-phase windings and a DC side connected to one of the output terminals, and wherein the other output terminal is directly connected to the other multi-phase winding.

11. The dual-voltage power generation system of claim 10, wherein the output terminal directly connected to one of the multi-phase windings has a variable frequency AC output, the other output terminal has a DC output, the prime mover is configured to control a speed of a shaft that drives the generator, the AC/DC converter is configured to control its AC-side electrical frequency, and power sharing between the AC and the DC outputs is independent of the shaft speed.

12. The dual-voltage power generation system of claim 10, wherein the output terminal directly connected to one of the multi-phase windings has a fixed frequency AC output, the other output terminal has a DC output, the prime mover is configured to control a speed of a shaft that drives the generator, the AC/DC converter is configured to control its AC-side electrical frequency, and power sharing between the AC and the DC outputs is dependent on the shaft speed.

13. A method of configuring a dual-voltage power generation system for operation, the method comprising:
configuring a prime mover for driving a doubly-fed induction generator at variable speed, the generator comprising a multi-phase stator winding and a multi-phase rotor winding having different turns ratios;
electrically connecting a first output terminal of the dual-voltage power generation system to the multi-phase stator winding;
electrically connecting a second output terminal of the dual-voltage power generation system to the multi-phase rotor winding;
connecting an AC side of a first converter to one of the multi-phase windings and an AC or DC side of the first converter to one of the output terminals; and
electrically isolating the first output terminal from the second output terminal so that the dual-voltage power generation system has two isolated power supply outputs at different voltage levels in a first configuration.

14. The method of claim 13, wherein the first converter is an AC/DC converter having an AC side connected to one of the multi-phase windings and a DC side connected to one of the output terminals.

15. The method of claim 14, further comprising:
connecting an AC side of a second AC/DC converter to the other one of the multi-phase windings and a DC side of the second AC/DC converter to the other one of the output terminals.

16. A power generation and distribution system, comprising:
a higher-voltage DC bus for supplying power to large drive-fed motors;
a lower-voltage DC bus for supplying power to small drive-fed motors; and
a first plurality of dual-voltage power generation systems each comprising:
a prime mover configured for adjustable speed operation;
a doubly-fed induction generator driven by the prime mover and comprising a multi-phase stator winding and a multi-phase rotor winding having different turns ratios;
a first DC output terminal electrically connected to the higher-voltage DC bus;
a second DC output terminal electrically connected to the lower-voltage DC bus and electrically isolated from the first DC output terminal;
a first converter having an AC side connected to the multi-phase stator winding and a DC side connected to the first DC output terminal; and
a second converter having an AC side connected to the multi-phase rotor winding and a DC side connected to the second DC output terminal.

17. The power generation and distribution system of claim 16, further comprising:
a lower-voltage AC bus for supplying power to at least one of direct-on-line AC motors and auxiliary AC loads; and
a second plurality of dual-voltage power generation systems each comprising:
a prime mover configured for adjustable speed operation;
a doubly-fed induction generator driven by the prime mover and comprising a multi-phase stator winding and a multi-phase rotor winding having different turns ratios;
a DC output terminal electrically connected to the higher-voltage DC bus;
an AC output terminal directly connected to the multi-phase rotor winding and electrically connected to the lower-voltage AC bus, the AC output terminal being electrically isolated from the DC output terminal; and
a converter having an AC side connected to the multi-phase stator winding and a DC side connected to the DC output terminal.

18. The power generation and distribution system of claim 16, wherein at least one of the higher-voltage DC bus and the lower-voltage DC bus is electrically connected to an AC grid.

19. A power generation and distribution system, comprising:
a higher-voltage DC bus for supplying power to drive-fed motors;
a lower-voltage AC bus for supplying power to at least one of direct-on-line AC motors and auxiliary AC loads; and
a plurality of dual-voltage power generation systems each comprising:
a prime mover configured for adjustable speed operation;
a doubly-fed induction generator driven by the prime mover and comprising a multi-phase stator winding and a multi-phase rotor winding having different turns ratios;
a DC output terminal electrically connected to the higher-voltage DC bus;
an AC output terminal directly connected to the multi-phase rotor winding and electrically connected to the lower-voltage AC bus, the AC output terminal being electrically isolated from the DC output terminal; and
a converter having an AC side connected to the multi-phase stator winding and a DC side connected to the DC output terminal.

20. The power generation and distribution system of claim 19, wherein the lower-voltage AC bus is configured for operation at a fixed frequency, the power distribution system further comprising:
a plurality of single-voltage power generation systems electrically connected to the higher-voltage DC bus.
